(19) United States
(12) Patent Application Publication
(10) Pub. No.: US 2016/0110846 A1
(43) Pub. Date: Apr. 21, 2016

(54) AUTOMATIC DISPLAY IMAGE ENHANCEMENT BASED ON USER'S VISUAL PERCEPTION MODEL

(71) Applicant: QUALCOMM Incorporated, San Diego, CA (US)

(72) Inventors: Hee Jun PARK, San Diego, CA (US); Jeong-Ho WOO, San Diego, CA (US); Woonyoung JANG, San Diego, CA (US)

(21) Appl. No.: 14/520,236

(22) Filed: Oct. 21, 2014

(51) Int. Cl. G06T 5/00; G09G 5/10; G09G 5/02

(52) U.S. Cl. CPC G06T 5/00; G09G 5/02; G09G 5/10; G06T 5/006; G09G 2360/144

(57) ABSTRACT

In an aspect of the disclosure, a method, a computer program product, and an apparatus are provided. An apparatus determines whether a vision-altering object is present between the apparatus and at least one eye of a user. The apparatus identifies the vision-altering object as corresponding to a previously characterized object in response to determining that the vision-altering object is present between the device and the at least one eye of the user. The apparatus adjusts an image displayed at the apparatus based on one or more characteristics of the previously characterized object. Accordingly, the presence of the vision-altering object is compensated to allow the user to perceive an image that is closer to the image despite the presence of the vision-altering object.

### BACKGROUND

1. Field

The present disclosure relates generally to images displayed by display devices, and more particularly to enhancing or improving a user's perception of such images in various situations and environments.

2. Background

A device such as a mobile terminal (or a similar portable device) may include a display device. The display device may display images including moving images. The displayed images are then perceived by a user of the device. With respect to the displayed image, the perceived image may be distorted due to one or more factors, including factors that are external to the device. Such factors may include a level of ambient light and/or a vision-altering object that is positioned between the display device and the eyes of the user (e.g., a pair sunglasses being worn by the user).

### SUMMARY

In an aspect of the disclosure, a method, a computer program product, and an apparatus are provided. An apparatus determines whether a vision-altering object is present between the apparatus and at least one eye of a user. The apparatus identifies the vision-altering object as corresponding to a previously characterized object in response to determining that the vision-altering object is present between the device and the at least one eye of the user. The apparatus adjusts an image displayed at the apparatus based on one or more characteristics of the previously characterized object.

In another aspect, the apparatus receives a base image for display. The apparatus senses a presence of one or more vision-altering objects located between the apparatus and at least one eye of a user. The apparatus processes the base image for the display at the apparatus, to reduce distortion perceived by the user when viewing the display of the base image, in response to sensing the presence of the vision-altering object. The distortion is induced by at least two of a plurality of sources, the plurality of sources including the one or more vision-altering objects, ambient light, and physiology of an eye of the user. The apparatus displays the processed base image.

### BRIEF DESCRIPTION OF THE DRAWINGS

FIG. 1 is a block diagram of a user device.

FIG. 2 is a diagram illustrating characterization of a color and transmission of vision-altering eyewear.

FIG. 3 is a diagram illustrating a visual experience model and integrated image compensation algorithm.

FIG. 4 illustrates examples of input/output curves that may also be used to enhance perception of a displayed image.

FIGS. 5(a) and 5(b) illustrate examples of input/output curves that may also be used to enhance perception of a displayed image.

FIG. 6 is a flow chart of a method of operating a device.

FIG. 7 is a flow chart of a method of operating a device.

FIG. 8 is a conceptual data flow diagram illustrating the data flow between different modules/means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of enhancing a user's perception of a displayed image, e.g., by reducing the effects of distortion (or degradation) caused by one or more factors, are presented below with reference to various apparatuses and methods. These apparatuses and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

When an image is displayed on a display device (e.g., the display device of a user device such as a mobile terminal), the image that is perceived by a user may be distorted due to one or more factors. These factors may include factors that are external to the device, e.g., ambient light and/or a vision-altering object that is located between the display device and the eye of the user. Such factors may also include physiological characteristics of the user's eye itself

For example, the vision-altering object may include a pair of sunglasses (or tinted glasses) that the user is wearing over his eyes. When the user views a displayed image while wearing such eyewear, the image that he perceives may appear much darker than the actual image. In addition, the perceived brightness values of a particular primary color (e.g., red (R), green (G) or blue (B)) may be quite different from the actual brightness values of the image. For example, if the user is wearing eyewear that features blue-tinted lenses, it may be difficult for the user to accurately perceive the blue channel of the displayed image.

As known in the art of digital photography, each pixel of an image may be considered as having a color that is produced by a combination of the RGB primary colors. When the user is wearing sunglasses, the perceived brightness value of the RGB combination may be less than the actual brightness value.

Each of the RGB primary colors may be referred to as a “color channel” (or “channel”). For a particular channel, the brightness value (or intensity) of a particular pixel may be expressed as a series of bits, the length of which is referred to as the bit depth. If the bit depth for a particular channel is 8 bits, then the brightness value can range from 0 to 255, for example. When the user is wearing eyewear that features blue-tinted lenses, the perceived brightness value of the blue channel may be less than the actual brightness value.

Distortion that is perceived by the user may be caused by additional sources. For example, ambient light (e.g., sunlight) may also cause the perceived image to be different from the displayed image. When the user is wearing sunglasses outdoors in a bright and sunny environment, the distortion may be so great that the perceived image appears totally unlike the displayed image. In such a situation, the user may elect to remove the sunglasses and/or move to a shaded area in order to better observe the displayed image. Either of these options may pose an inconvenience to the user.

Aspects of the disclosure are directed to autonomously enhancing a user's perception of a displayed image.

According to aspects, a user device (e.g., a mobile terminal) uses a camera to capture an image of the user's face periodically. The user device processes the images to autonomously detect the presence of sunglasses or glasses, recognize lens darkness/colors, and estimate an ambient brightness by comparing the skin color captured with a reference skin color. The user device enhances perception of the display image by adjusting brightness, color palette, contrast, and/or font size of the displayed image corresponding to factors that may include the status of the user's sunglasses and ambient brightness. In this regard, the user device may compensate for at least one color of the color palette to enhance perception of the R, G or B channel. For example, if the user is wearing eyewear that features blue-tinted lenses, the user device may increase the brightness value of the blue channel of the displayed image.

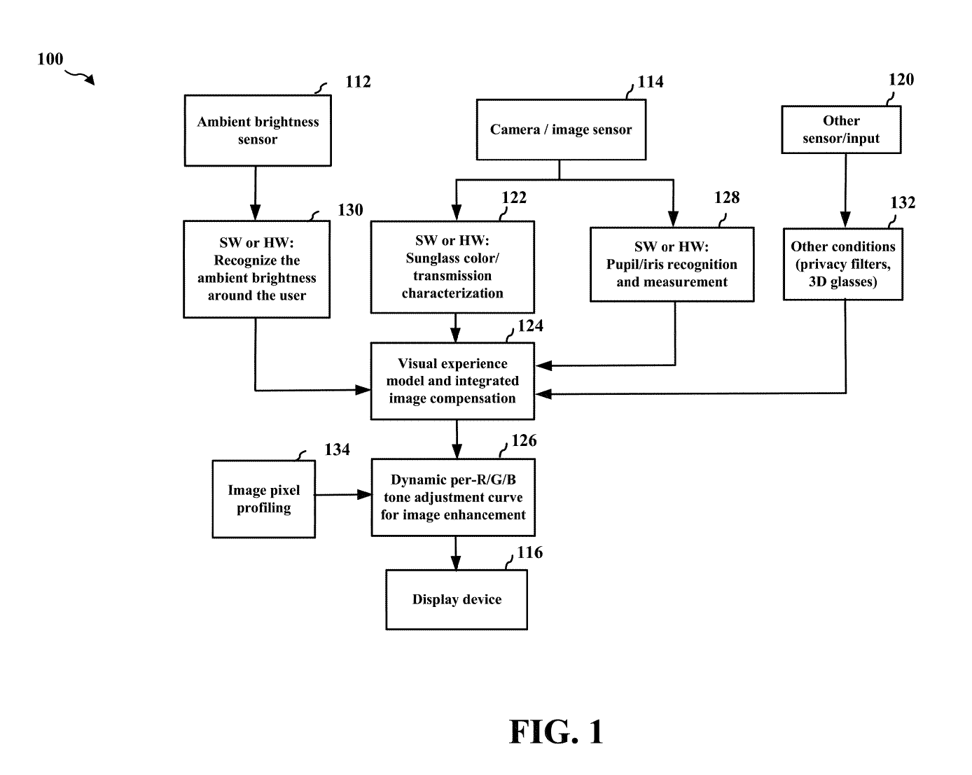

FIG. 1 is a block diagram 100 of a user device 102 according to one embodiment. The user device 102 may include a processor (which may include module 122, module 128, module 130 and/or module 134), an ambient brightness sensor 112, and a camera (or image sensor) 114. The camera 114 may be located on a front surface of the user device to facilitate, for example, the taking of self portraits. The user device 102 may also include a display device 116, and a sensor 120.

The user device 102 may be a user terminal, a mobile terminal or a similar portable device. The processor may control the operations of the mobile terminal. The user device 102 may include a module 122 for controlling sunglass color/transmission characterization, a module 124 for controlling a visual experience model and integrated image compensation, a module 126 for controlling dynamic selection of a tone adjustment curve (e.g., a red (R), blue (B) or green (G) tone adjustment curve) for image enhancement, a module 128 for pupil/iris recognition and measurement, a module 130 for recognizing the ambient brightness around the user terminal, and a module 134 for performing image pixel profiling. The modules 122, 124, 126, 128, 130, 134 may be software modules running in a processor, and may be resident/stored in a computer readable medium, one or more hardware modules coupled to the processor, or some combination thereof.

The modules 122, 124, 126, 128, 130, 134 may operate separately and independently of each other. Alternatively, the modules 122, 124, 126, 128, 130, 134 may operate according to a particular sequence or flow such that a later-operated module(s) uses an output(s) provided by an earlier-operated module(s). For example, the modules 122, 124 and 126 may operate according to the following sequence (from first to last): 122, 124, 126. It is understood that these modules may operate according to various other sequences.

The ambient brightness sensor 112 may be controllable to measure an ambient brightness of the environment in which the user device is located. The camera/image sensor 118 may be controllable to capture images, including photographic images. It is understood that the user device 102 may include two camera/image sensors 118, which may be located, for example, on the front and back of the user device 102.

The display device 116 may be controllable to display images for viewing by the user. Such images may be stored in a memory storage device. If the display device 116 includes a touch screen, then the display device 116 may operate as an input device as well as an output device. The structure of the user device 102 may be configured to facilitate mating with a screen filter (e.g., a privacy filter) that is positioned over a portion of the user device (e.g., over the display device 116).

The memory storage device may be controllable to store not only images that can be displayed at the display device 116, but also application programs that are used to operate the user device 102. The sensor 120 may be controllable to sense the presence of certain objects in the vicinity of the user device. The conditions 132 that may be sensed include the presence of a screen filter positioned over the user device or the presence of a particular piece of eyewear (e.g., three-dimensional (3D) glasses) that is worn over the user's eyes.

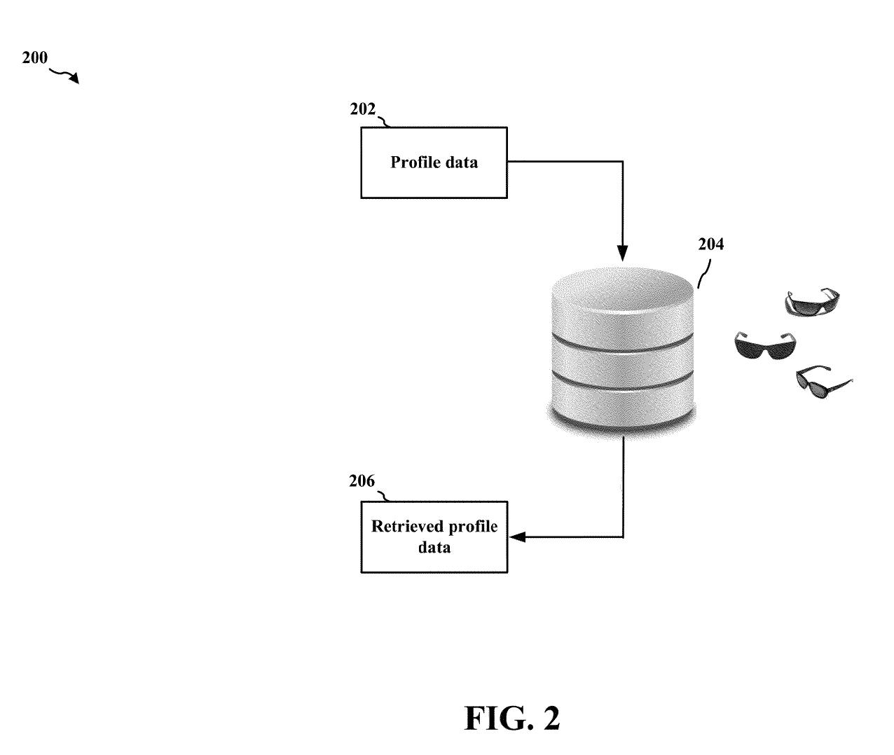

FIG. 2 is a diagram 200 illustrating characterization of a color and transmission of a vision-altering object (e.g., eyewear such as a pair of sunglasses). Profile data 202 regarding the eyewear is determined and collected. The profile data 202 may include at least a color of lenses of the eyewear or a transmission of the lenses. The transmission may indicate a degree to which the lenses are transparent (or, conversely, a degree to which the lenses are opaque).

The profile data 202 may be stored in a database 204. The database may reside in a memory device internal to the user device 102 (e.g., memory device 118 of FIG. 1). Alternatively, the database 204 may reside outside the user device 102.

At a later time, the user device 102 may identify a piece of eyewear that is worn by a user as corresponding to a particular piece of eyewear that was characterized by the user device at an earlier time. For example, the user device 102 may identify the eyewear by recognizing structural features such as the shape or the frame and/or the size of the eyewear. Alternatively or in addition, the user device 102 may identify the eyewear based on a rough estimate (or measurement) of the transparency of the eyewear. Accordingly, profile data 206 of the previously characterized eyewear is retrieved from the database 204. As such, the user device need not again characterize the eyewear worn by the user. Because the disclosed identification requires less processing workload than a full characterization process, execution time and power consumption may be reduced, and convenience for the user is enhanced.

Creation of the profile data 202 that is stored in the database 204 will now be described in more detail. It is understood that a user device (e.g., user device 102) may use any of known techniques to determine whether a vision-altering object (e.g., a pair of sunglasses) is present over the eyes of a user. Such techniques may relate to facial detection and/or facial recognition, for example.

Whether or not the user is wearing sunglasses, the user device may use a camera (e.g., camera/image sensor 114 of FIG. 1) to perform a facial detection, in order to detect various aspects and/or features of the user's face. Such aspects may include the skin tone of the user's face and/or the shape of his face. Features that are detected may include the eyes, nose and/mouth of the user, as well as relative positions of these features on the user's face.

Also using such techniques, the user device may detect the presence of an object (e.g., sunglasses) over the eyes of the user. If the user is wearing sunglasses while the user device is performing the characterization, the user device may determine a general assessment of the transmission of the sunglasses. For example, if the user device is able to detect the eyes of the user beneath the sunglasses, the user device may conclude that the sunglasses are transparent (to at least some degree). As another example, if the user device is not able to detect the eyes of the user beneath the sunglasses, the user device may conclude that the sunglasses are opaque. As such, the user device may determine a transmission of sunglasses worn by the user as being transparent or opaque using techniques relating to facial detection and/or facial recognition.

The transmission of the sunglasses may be estimated to a more specific degree. Such an estimation can be performed using two images that are taken with the camera.

For example, the camera may be controlled to take a first image (“image1”).

The image1 may be taken while the user device is placed on a stationary, flat surface. The sunglasses are not captured in the image1. A second image (“image2”) is taken while the sunglasses are placed over the camera. As such, the sunglasses are captured in the image2. To improve the accuracy of the estimation, both image1 and image2 may be captured at the same FOV (field of view) and while the user device is at a same position.

A computer program or application software (which may be referred to as a mobile app) that is run by the user device may be used to facilitate the capturing of the two images noted above. The execution of such a program will now be described in more detail.

After execution of the program is initiated, the user may be prompted to place the user device on a stationary, flat surface. After the user device is placed on such a location, the user device captures the image1. The user device may intelligently decide when to capture image1 based on motion estimation. For example, the user device may capture one image at every unit time (e.g., at every 0.5 seconds, such that 2 frames are captured in one second). The user device computes an amount of motion by comparing the current frame against a previous frame. If the computed amount of motion is less than a certain threshold, then the user device proceeds to capture the image1.

After the image1 is captured, the user device may lock various camera settings (e.g., auto exposure and/or auto white balance) to ensure that the image2 is captured at the same settings. The user device prompts the user to place the sunglasses over the lens of the camera (e.g., so that the sunglasses covers the camera lens). Once the user device detects the presence of the sunglasses, the user device captures the image2. The user device may then proceed to estimate the transmission of the sunglasses using the image1 and image2 that are captured.

The estimation may begin by pre-processing both images. For example—for ease of processing, both image1 and image2 may be scaled down to a lower resolution (e.g., 320×240 pixels). The images may then be input to a lowpass filter to obtain a local brightness. An inverse gamma image (as known in the art of image processing) may be taken for image1 and for image2.

The estimation may be performed based on Commission on Illumination (CIE) color space characteristics or on a per-channel (RGB) basis.

Regarding color space characteristics, the inverse-Gamma images of image1 and image2 are converted to CIE XYZ color space characteristics. In the CIE model, the Y values are representative of luminance. The transmission of the sunglasses may then be estimated as an average of ratios of CIE-Y values for various pixels, as expressed in Equation 1 below.

$$\tilde{T} = average \{ \frac{{Y}_{2} ( i , j )}{{Y}_{1} ( i , j )} \} , \\ ( i , j ) for {Y}_{L} \leq {Y}_{1} ( i , j ) \leq {Y}_{U} \qquad [ Equation 1 ]$$

In the above Equation 1, Y₁(i,j) denotes the CIE-Y value at the (i,j) coordinate of image1, and Y₂(i,j) denotes the CIE-Y value at the (i,j) coordinate (or pixel) of image2. Y_{L} and Y_{U} respectively denote the lower and upper bounds of the CIE-Y values that are selected for use in the estimation. As expressed in Equation 1, the CIE-Y values are selected based on comparison of the values Y₁(i,j) against the lower and upper bounds Y_{L} and Y_{U}.

As noted earlier, the transmission may also be estimated on a per-channel (RGB) basis. In more detail, transmission factors \tilde{T}_{R}, \tilde{T}_{G}, \tilde{T}_{B} for the RGB channels can be estimated from the inverse-Gamma images of image1 and of image2. The inverse-Gamma images need not be converted to CIE-XYZ values. Accordingly, the transmission factors may be calculated directly from the inverse-Gamma images. The transmission factor \tilde{T}_{R} of the sunglasses may then be estimated as an average of ratios of the R brightness values for various pixels, as expressed in Equation 2 below.

$$= average \{ \frac{{R}_{2} ( i , j )}{{R}_{1} ( i , j )} \} for {R}_{L} \leq {R}_{1} ( i , j ) \leq {R}_{U} \qquad [ Equation 2 ]$$

In the above Equation 2, R₁(i,j) denotes the R-channel brightness value at the (i,j) coordinate (or pixel) of image1, and R₂(i,j) denotes the R-channel brightness value at the (i,j) coordinate of image2. R_{L} and R_{U} respectively denote the lower and upper bounds of the brightness values that are selected for use in the estimation. As expressed in Equation 2, the R brightness values are selected based on comparison of the values R₁(i,j) against the lower and upper bounds R_{L} and R_{U}.

The transmission factors for the green (G) and blue (B) channels \tilde{T}_{G}, \tilde{T}_{B} may be calculated in a similar manner, as expressed in Equations 3 and 4 below.

$$\begin{matrix}= average \{ \frac{{G}_{2} ( i , j )}{{G}_{1} ( i , j )} \} for {G}_{L} \leq {G}_{1} ( i , j ) \leq {G}_{U} & [ Equation 3 ] \\ = average \{ \frac{{B}_{2} ( i , j )}{{B}_{1} ( i , j )} \} for {B}_{L} \leq {B}_{1} ( i , j ) \leq {B}_{U} & [ Equation 4 ]\end{matrix}$$

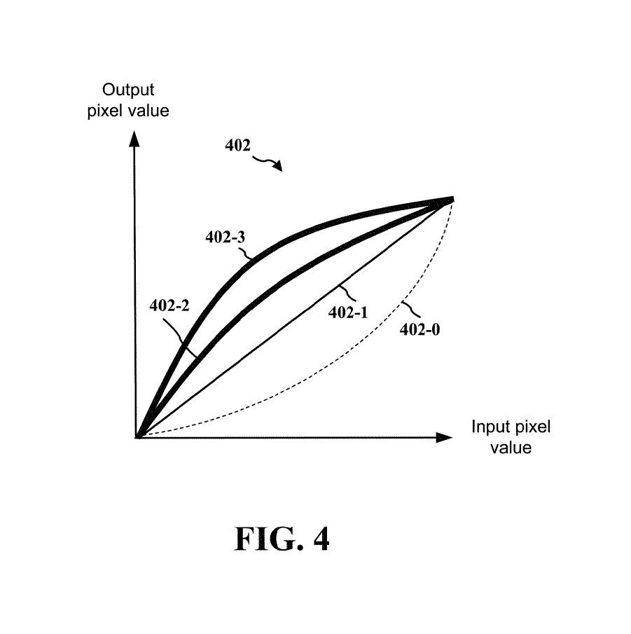

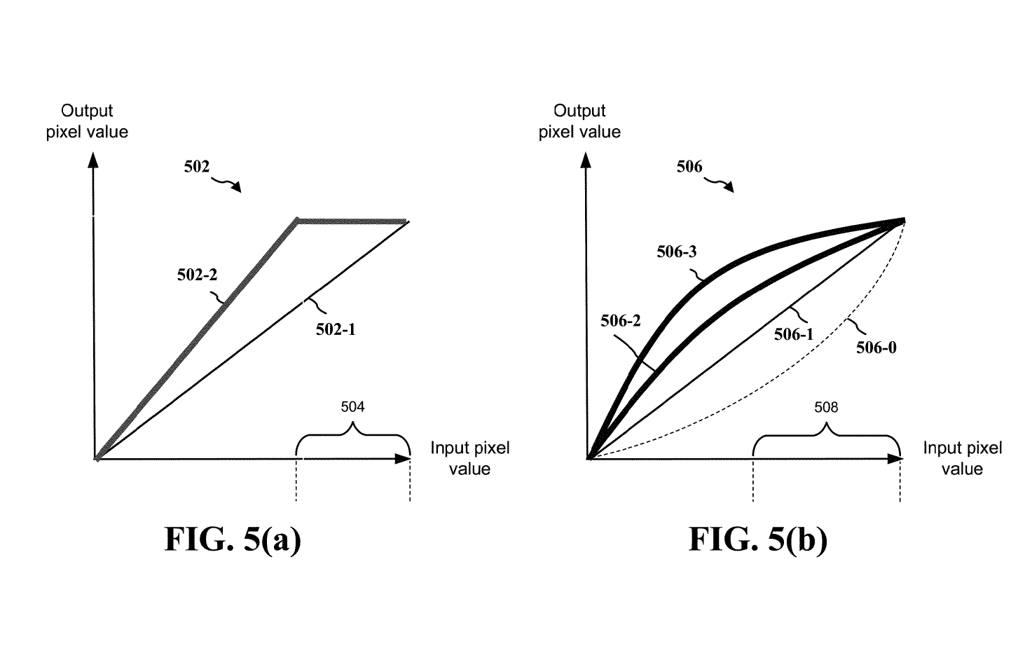

Usage of the estimated transmission values will be described in more detail below (e.g., with reference to FIGS. 4, 5(a) and 5(b)).

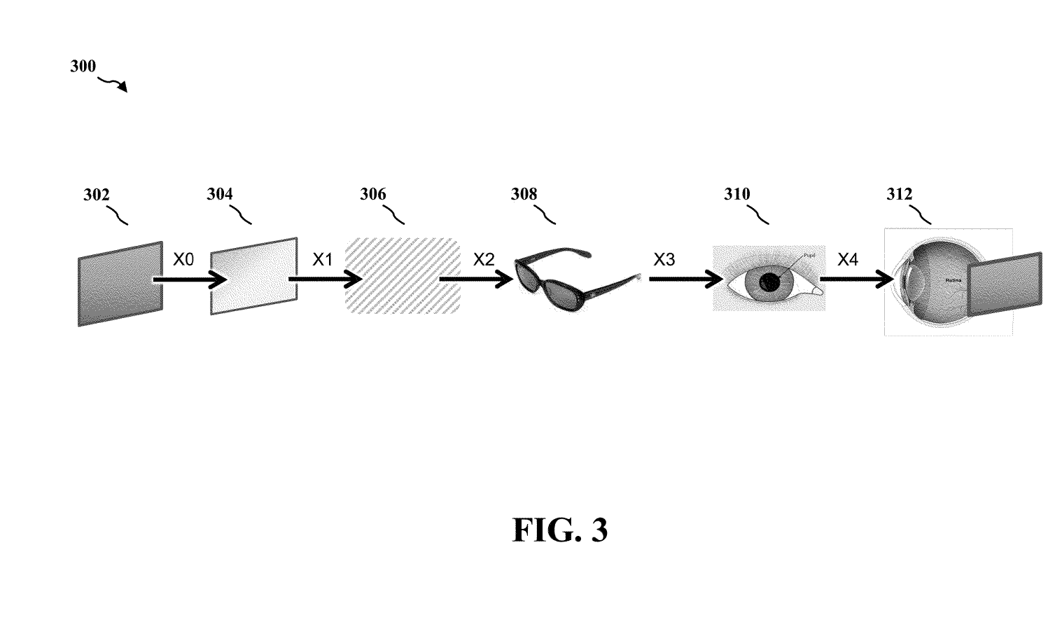

FIG. 3 is a diagram 300 illustrating a visual experience model and integrated image compensation algorithm. As noted earlier, a displayed image that is perceived by a user may be distorted due to multiple factors. Each of these multiple factors may introduce its own component (or portion) of the distortion that is perceived by the user. Due to such distortion, the image perceived by the user may be different from the image that is displayed.

With reference to FIG. 3, a model may be used to represent, mathematically, the combined effect of the different components of the distortion as a single function (e.g., a transform function). For example, a single transform function may be used to represent the combined effect (e.g., cascade effect due to the different factors). Similarly, a single inverse transform function may be used to compensate for this combined effect.

With reference to FIG. 3, a base image 302 is displayed at a display device (e.g., display device 116 of FIG. 1), and the displayed image 304 is perceived by the user's eye 312. One or more factors may distort the user's perception of the displayed image 304. These factors may include ambient light 306 (e.g., sunlight, or artificial light produced by a light bulb), sunglasses 308 and/or physiological characteristics of the user's pupil 310.

A transfer function denoted as Transform_amb( ) represents the distortion that is introduced by the ambient light 306. The transfer function Transform_amb( ) may affect parameters including RGB channel parameters, brightness, contrast, etc. The inverse of the noted transfer function—i.e., a function that is a “reverse” of the noted transfer function—may be expressed as Transform_amb⁻¹( ). If X1 denotes the displayed image 304, then the displayed image as distorted by the ambient light 306 (denoted as X2) may be expressed according to Equation 5 below.

X2=Transform_amb(X1) [Equation 5]

The function Transform_amb(−) may be determined as a mathematical equation for color space—for example, X2=Transform_amb(X1)=X1+L_amb where L_amb denotes the brightness adder for the input image X1. As a result, when ambient light is too strong, the contrast ratio for the resulting image X2 becomes smaller. Therefore, it may become difficult for the user to recognize more delicate images, text and lines having similar colors and brightness levels.

Similarly, a transfer function denoted as Transform_glass( ) represents the distortion that is introduced by the sunglasses 308. The transfer function Transform_glass( ) may affect parameters including RGB channel parameters, brightness, contrast, etc. The inverse of the noted transfer function—i.e., a function that is a “reverse” of the noted transfer function—may be expressed as Transform_glass⁻¹( ). If X2 denotes the displayed image as distorted by the ambient light 306, then the displayed image as further distorted by the sunglasses 308 (denoted as X3) may be expressed according to Equation 6 below.

X3=Transform_glass(X2) [Equation 6]

The user's pupil 310 may distort the user's perception due, for example, to a change in the size of the pupil. Such a change in size may be due, for example, to dilation or other causes. A transfer function denoted as Transform_pupil( ) represents the distortion that is introduced by the pupil 310. The transfer function Transform_pupil( ) may affect parameters including RGB channel parameters, brightness, contrast, etc. The inverse of the noted transfer function—i.e., a function that is a “reverse” of the noted transfer function—may be expressed as Transform_pupil⁻¹( ). If X3 denotes the displayed image as distorted by the ambient light 306 and then by the sunglasses 308, then the displayed image as further distorted by the pupil 310 (denoted as X4) may be expressed according to Equation 7 below.

X4=Transform_pupil(X3) [Equation 7]

A single inverse transform function may be used to compensate for the combined effect of the different sources of distortion. This function may represent an integration of the respective inverses of the individual transfer functions. Such a function—denoted as Transform_enhance ( )—may be expressed according to Equation 8 below.

Transform_enhance=Transform_amb⁻¹(Transform_glass⁻¹(Transformₚᵤₚᵢₗ⁻¹( ))) [Equation 8]

As noted earlier, the above function represents an integration of the respective inverses of the individual transfer functions. Therefore, when the function Transform_enhance( ) is applied to the base image XO and this processed image X0′ is displayed at the display device (the displayed image will be referred to as X1′), the image that is ultimately perceived by the user may more closely approximate the base image X0. In other words, even when the displayed image X1′ is distorted by the ambient light 306, the sunglasses 308 and the pupil 310, the image that is ultimately perceived by the user (X4′) may still approximate the base image (X0). In ideal conditions, the image that is ultimately perceived by the user (X4′) would be identical (or nearly identical) to the base image (X0).

It is understood that other additional factors may introduce distortion affecting the image that is perceived by the user. For example, such factors may include a privacy filter that is disposed over the display device. Transfer functions similar to the functions described earlier may be used to address the distortion introduced by such additional factors.

The specific sequence expressed in Equation 8 represents but one example, and it is understood that the function Transform_enhance( ) may be expressed according to a different sequence. For example, the function Transform_enhance( ) may be expressed according to Equation 9 below.

Transform_enhance=Transform_pupil⁻¹(Transform_glass⁻¹(Transform_{amb}⁻¹( ))) [Equation 9]

Further, it is understood that the function Transform_enhance( ) may be expressed according to yet another sequence. Changing the sequence according to which the function Transform_enhance( ) is expressed may result in mathematical differences. However, due to limitations of the human eye, the mathematical differences may be so slight that they are not readily identifiable by the human eye.

FIG. 4 illustrates examples of input/output curves 402 that may be used to enhance perception of a displayed image. Such curves may be utilized independently or in combination with the processes described above with reference to FIG. 3. The curves 402 may be referred to as image tone adjustment curves. As illustrated in FIG. 4, the curves may be linear (see curve 402-1) or non-linear (see curves 402-2, 402-3 and 402-0).

Each of the curves establishes relationships between an input pixel value (e.g., a brightness value or “tone”) and an output pixel value. In other words, each curve maps an input pixel value to a particular output pixel value. The linear curve 402-1 may have a unity slope (i.e., a slope of 1). If this curve has a slope of 1, it effectively maps each input pixel value to itself.

To enhance perception of a particular image that is displayed, a particular curve of the curves 402 may be selected. The selection may be based on the estimated transmission that was disclosed earlier with reference to FIG. 2. For example, the selection may be based on a display image adjustment factor A. The display image adjustment factor may be expressed according to Equation 10 below.

A=f(\tilde{T}, L_{ALS}) [Equation 10]

In the above Equation 10, \tilde{T} denotes the estimated transmission. L_{ALS} is denotes a light strength that is measured by an ambient light sensor (ALS) (e.g., ambient brightness sensor 112 of FIG. 1).

Depending on the value of the display image adjustment factor A, a particular curve may be selected. For example, a value of the display image adjustment factor A that is equal to 1 may be interpreted as meaning “No adjustment required.” Therefore, if the value of A is (or is close to) 1, then the curve 402-1 may be selected. As described earlier, this curve may effectively map each input pixel value to itself.

Also for example, if the value of A is greater than 1, one of the curves 402-2, 402-3 may be selected. The particular curve that is selected may be based on the degree to which A is larger than 1. As illustrated in FIG. 4—the curve 402-3 is steeper than the curve 402-2. Compared to the curve 402-2, the curve 402-3 generally maps a same input pixel value to a higher output pixel value. Therefore, values of A that are equal to 2 and 3, for example, may result in the selection of curves 402-2 and 403-3, respectively.

Also for example, if the value of A is less than 1, a curve that falls below the unity curve 402-1 may be selected. For example, the curve 402-0 may be selected. Such a curve may map a particular input pixel value to an output pixel value that is less than the particular input pixel value.

As such, the selection of the curve may be based on the estimated transmission disclosed earlier with reference to FIG. 2. As also disclosed with reference to FIG. 2, separate transmission factors \tilde{T}_{R}, \tilde{T}_{G}, \tilde{T}_{B} may be determined for the RGB channels. Accordingly, separate display image adjustment factors A_{R}, A_{G}, A_{B} may be determined based on the transmission factors \tilde{T}_{R}, \tilde{T}_{G}, \tilde{T}_{B}, respectively (see, e.g., Equation 10). Accordingly, a different curve (e.g., from among curves 402) may be selected for each RGB channel based on the separate display image adjustment factors A_{R}, A_{G}, A_{B}.

The shapes of the image tone adjustment curves may be configured to reduce the likelihood of hard clipping. Hard clipping occurs, for example, when input pixel values that are above a particular value (which may be referred to as the highlights) all become mapped to the same output pixel value (e.g., a maximum output pixel value). When hard clipping occurs, one or more portions of a displayed image may be perceived as being solid white in appearance. When this occurs, the highlights are said to be “clipped” or “blown.”

FIGS. 5(a) and 5(b) illustrate examples of input/output curves 502, 506 that may also be used to enhance perception of a displayed image. FIG. 5(a) illustrates a curve 502-2 that may result in hard clipping. As illustrated in FIG. 5(a), input pixel values that fall in a “highlights” range 504 all become mapped to a same output pixel value. Therefore, the details of the corresponding pixels are effectively lost, and color saturation occurs.

To reduce the occurrence of such losses, the image tone adjustment curves may be configured as illustrated in FIG. 5(b). Unlike curve 502-2 of FIG. 5(a), the curves 506-2, 506-3 do not cause the highlights of the input to become clipped. Each of curves 506-2, 506-3 may be implemented by using an exponential function. Also, each of curves 506-2, 506-3 may be implemented by performing a linear combination of (1) a curve that does result in hard clipping (e.g., curve 502-2 of FIGS. 5(a)) and (2) a unity curve (e.g., curve 502-1 of FIG. 5(a)).

As described earlier, the selection of a particular curve (e.g., from curves 402 of FIG. 4) may be based on the estimated transmission of a vision-altering object (e.g., eyewear such as sunglasses). This selection may also be based on characteristics of the image itself (e.g., image 302 of FIG. 3) that is to be displayed.

For example, the selection may also be based on a histogram of the image. A RGB histogram may be generated by analyzing an image (e.g., its RGB brightness values) is analyzed, and counting the number of values that are at each level (e.g., each level from 0 through 255). The histogram may therefore indicate what is called the tonal range of the image.

Images that are taken in low-light environments (e.g., a dark nightclub) may mostly include tones that are in the shadows. Such images are referred to as “low key” images. In contrast, images that are taken in bright environments (e.g., outdoors on a bright and sunny day) may mostly include tones that are in the highlights. Such images are referred to as “high key” images.

By way of example, a curve may be selected depending on whether the image is considered to be “high key” or “low key.” For example, with reference to FIG. 5(b), an image that includes tones that mostly fall outside of the range 508 may be considered as a low key image. Accordingly, an appropriate curve may be selected to improve perception of such an image. For a low key image, the curve 506-3 may be selected. This would improve the user's perception of the displayed image.

Also with reference to FIG. 5(b), an image that includes tones that mostly fall within the range 508 may be considered as a high key image. Accordingly, an appropriate curve may be selected to improve perception of such an image. For a high key image, one of curves 506-1, 506-0 may be selected. This would improve the user's perception of the displayed image. For example, the curve 506-0 may provide the largest contrast for a high key image.

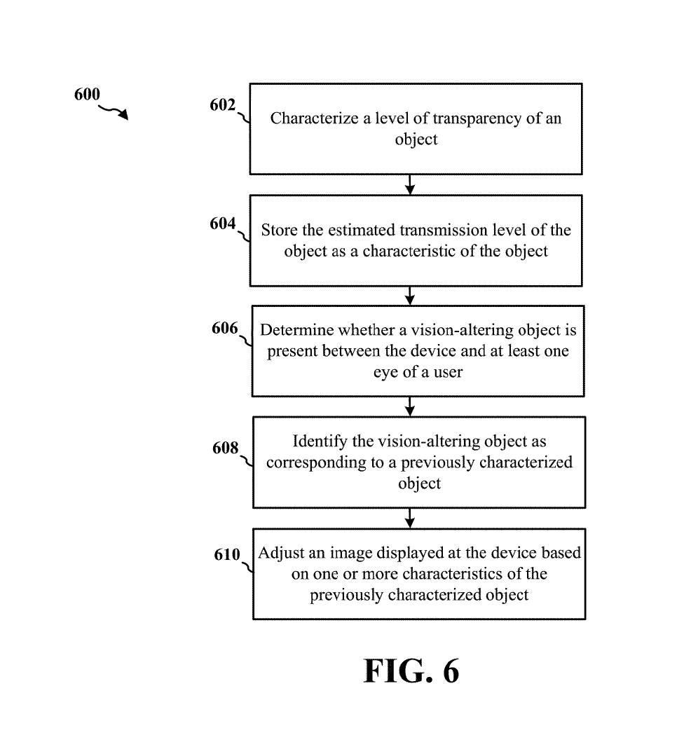

FIG. 6 is a flow chart 600 of a method of operating a device. At 602, a device (e.g., user device 102 of FIG. 1) characterizes a level of transparency of an object (e.g., a lens of a pair of sunglasses). Additionally, the device may determine a color of the object (e.g., a tint color of the lens). Additionally, the device may: capture a first image using a camera of the device; request the user to position the object within a field of view of the camera after capturing the first image; detect that the object is positioned within the field of view of the camera; capture a second image using the camera in response to detecting that the object is positioned within the field of view of the camera; and estimate a transparency characteristic of the object (e.g., a transmission level of the lens) based on CIE XYZ color space characteristics or RGB color model characteristics of the captured first image and the captured second image. Additionally, the device may compare a skin tone of an exposed portion of a face of the user with a skin tone of a covered portion of the face, the covered portion being covered by the object.

At 604, the device stores the transparency characteristic of the object (e.g., estimated transmission level of the lens) as a characteristic of the object. At 606, the device determines whether a vision-altering object is present between the device and at least one eye of a user. At 608, the device identifies the vision-altering object as corresponding to a previously characterized object.

At 610, the device adjusts an image displayed at the device based on one or more characteristics of the previously characterized object. Additionally, the device may adjust at least one of a brightness, a color palette, a contrast or a font size of the displayed image. Additionally, the device may compensate for at least one color of the color palette to enhance perception of at least one color among the R, G or B channels. Additionally, the device may sense an ambient brightness. Additionally, the device may calculate a display adjustment factor based on the estimated transmission level. Additionally, the device may select at least a display image tone adjustment curve or one or more display image tone adjustment values based on the calculated display image adjustment factor.

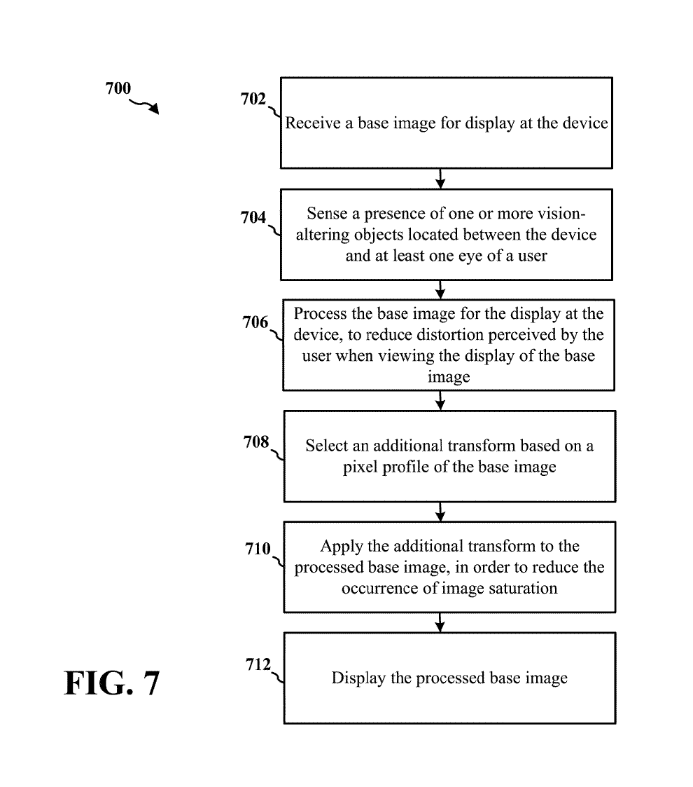

FIG. 7 is a flow chart 700 of a method of operating a device. At 702, the device (e.g., the user device 102 of FIG. 1) receives a base image for display at the device. At 704, the device senses a presence of one or more vision-altering objects located between the device and at least one eye of a user. At 706, the device processes the base image for the display at the device, to reduce distortion perceived by the user when viewing the display of the base image. Additionally, the device may apply a calculated transform to the base image.

At 708, the device selects an additional transform (e.g., a curve illustrated in FIG. 4 or FIG. 5(b)) based on a pixel profile of the base image. At 710, the device applies the additional transform to the processed base image, in order to reduce the occurrence of image saturation. At 712, the device displays the processed base image.

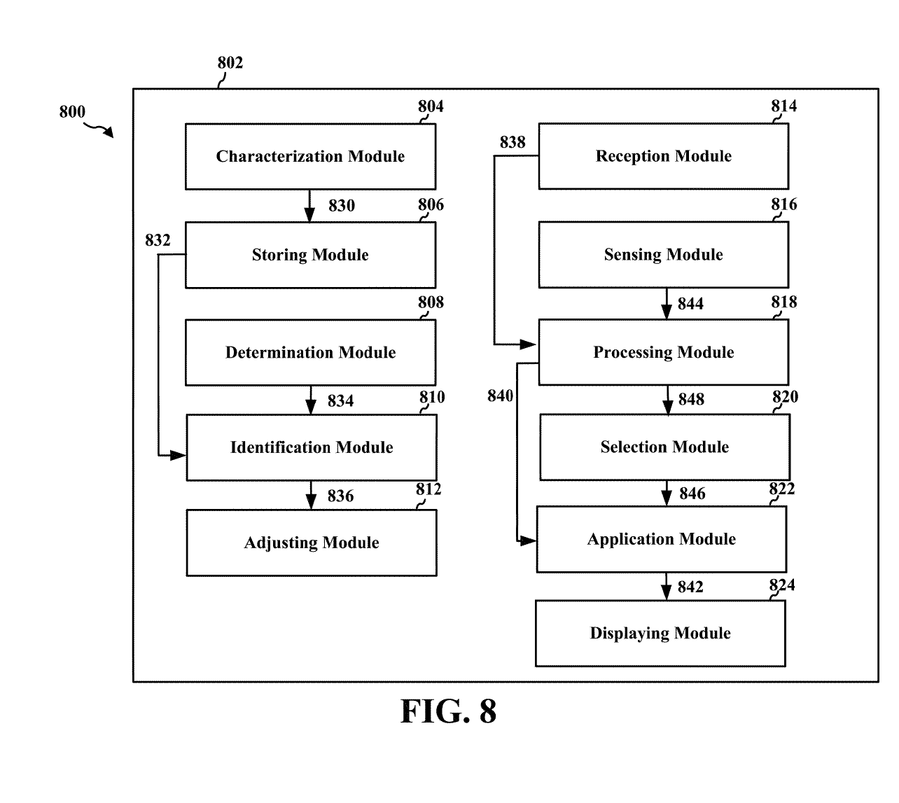

FIG. 8 is a conceptual data flow diagram 800 illustrating the data flow between different modules/means/components in an exemplary apparatus 802. The apparatus may be a mobile terminal. The apparatus 802 may include a characterization module 804, a storing module 806, a determination module 808, an identification module 810 and an adjusting module 812.

The characterization module 804 characterizes a level of transparency of an object (e.g., a lens of a pair of sunglasses). Additionally, the characterization module 804 may determine a color of the object (e.g., a tint color of the lens). The characterization module 804 provides the transparency characteristic to the storing module as output 830. The storing module 806 stores the transparency characteristic of the object (e.g., an estimated transmission level of the lens) as a characteristic of the object. The determination module 808 determines whether a vision-altering object is present between the apparatus and at least one eye of a user. The determination is provided to the identification module 810 as output 834. Based on output 832 from the storing module 806, the identification module 810 identifies the vision-altering object as corresponding to a previously characterized object. The identification module 810 provides one or more characteristics of the previously characterized object to the adjusting module 812 as output 836. The adjusting module 812 adjusts an image displayed at the apparatus based on the one or more characteristics of the previously characterized object.

The apparatus 802 may include a reception module 814, a sensing module 816, a processing module 818, a selection module 820, an application module 822 and a displaying module 824.

The reception module 814 receives a base image for display at the apparatus. The base image may be output to the processing module 818 as output 838. The sensing module 816 senses a presence of one or more vision-altering objects located between the apparatus and at least one eye of a user. Upon sensing the presence, the sensing module 816 provides an output 844 to the processing module 818. The processing module 818 processes the base image for the display at the apparatus, to reduce distortion perceived by the user when viewing the display of the base image. Additionally, the processing module 818 may apply a calculated transform to the base image. The processed image is provided to the application module 822 as output 840.

The selection module 820 selects an additional transform (e.g., a curve illustrated in FIG. 4 or FIG. 5(b)) based on a pixel profile of the base image, which may be provided by the processing module as output 848. The additional transform is provided to the application module as output 846. The application module 822 applies the additional transform to the processed base image, in order to reduce the occurrence of image saturation. The additionally processed base image is provided to the displaying module 824 as output 842. The displaying module 824 displays the additionally processed base image.

The apparatus may include additional modules that perform each of the steps of the algorithm in the aforementioned flow charts of FIGS. 6 and 7. As such, each step in the aforementioned flow charts of FIGS. 6 and 7 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

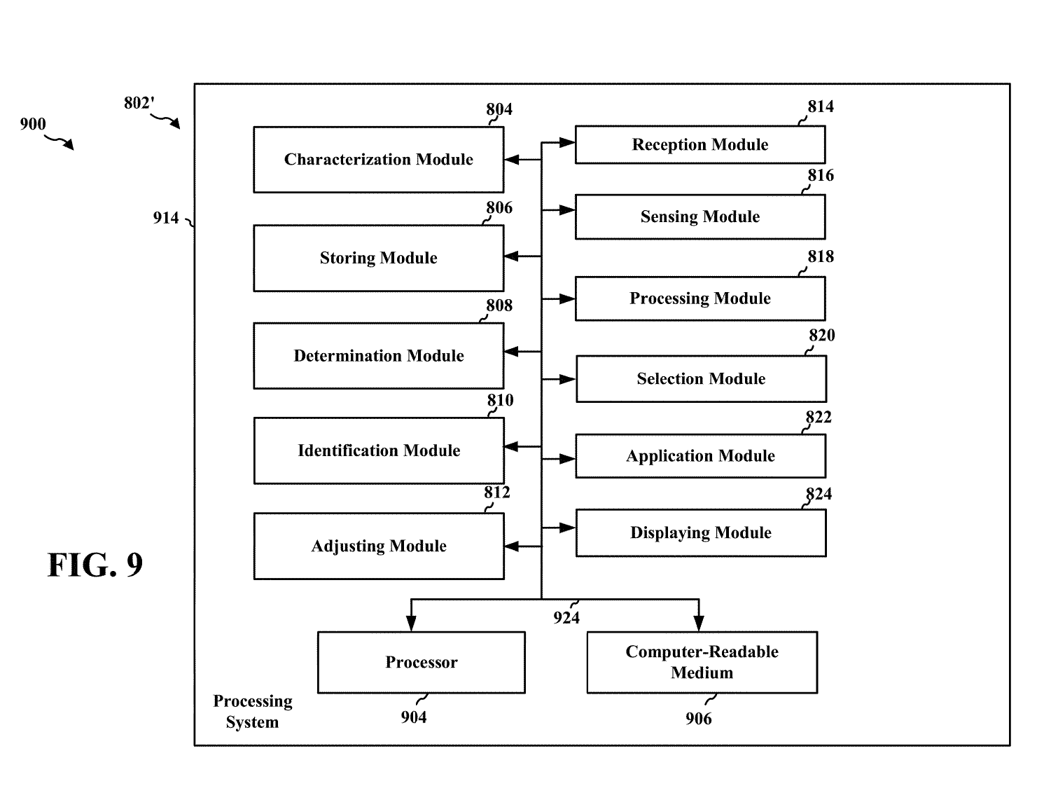

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 904, the modules 804, 806, 808, 810, 812, 814, 816, 818, 820, 822 and 824 and the computer-readable medium/memory 906. The bus 924 may also link various other circuits such as timing sources, peripherals, voltage regulators, and power management circuits, which are well known in the art, and therefore, will not be described any further.

The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system further includes at least one of the modules 804, 806, 808, 810, 812, 814, 816, 818, 820, 822 or 824. The modules may be software modules running in the processor 904, resident/stored in the computer readable medium/memory 906, one or more hardware modules coupled to the processor 904, or some combination thereof.

In one configuration, the apparatus 802/802′ includes means for characterizing a level of transparency of a lens of a pair of sunglasses, means for storing the estimated transmission level of the lens as a characteristic of the sunglasses, means for determining whether a vision-altering object is present between the device and at least one eye of a user, means for identifying the vision-altering object as corresponding to a previously characterized object, and means for adjusting an image displayed at the device based on one or more characteristics of the previously characterized object. In another configuration, the apparatus 802/802′ includes means for receiving a base image for display at the apparatus, means for sensing a presence of one or more vision-altering objects located between the apparatus and at least one eye of a user, means for processing the base image for the display at the apparatus, to reduce distortion perceived by the user when viewing the display of the base image, means for selecting an additional transform based on a pixel profile of the base image, means for applying the additional transform to the processed base image, in order to reduce the occurrence of image saturation, and means for displaying the processed base image. The aforementioned means may be one or more of the aforementioned modules of the apparatus 802 and/or the processing system 914 of the apparatus 802′ configured to perform the functions recited by the aforementioned means. As described supra, the processing system 914 may include the processor 904. As such, in one configuration, the aforementioned means may be the processor 904 configured to perform the functions recited by the aforementioned means. Also, the aforementioned means may be one or more of the processor 110, ambient brightness sensor 112, camera/image sensor 114, display device 116, memory storage device 118, or sensor 120 of FIG. 1.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of operating a device, comprising:
determining whether a vision-altering object is present between the device and at least one eye of a user;
identifying the vision-altering object as corresponding to a previously characterized object in response to determining that the vision-altering object is present between the device and the at least one eye of the user; and
adjusting an image displayed at the device based on one or more characteristics of the previously characterized object.

2. The method of claim 1, wherein the adjusting the displayed image comprises adjusting at least one of a brightness, a color palette, a contrast, or a font size of the displayed image.

3. The method of claim 2, wherein the adjusting the at least one of the brightness, the color palette, the contrast, or the font size of the displayed image comprises increasing at least one of the brightness, the contrast, or the font size of the displayed image.

4. The method of claim 2, wherein the adjusting the at least one of the brightness, the color palette, the contrast, or the font size of the displayed image comprises compensating for at least one color of the color palette to enhance perception of a Red (R), Green (G) or Blue (B) channel.

5. The method of claim 1, wherein the adjusting the displayed image comprises sensing an ambient brightness.

6. The method of claim 1, wherein the vision-altering object comprises at least one of sunglasses, three-dimensional (3D) glasses, a response of a pupil at the at least one eye, or a privacy filter disposed over at least a portion of the device.

7. The method of claim 6, wherein the vision-altering object comprises the sunglasses, and wherein the method further comprises characterizing a level of transparency of a lens of the sunglasses.

8. The method of claim 7, wherein the characterizing the level of transparency comprises determining a tint color of the lens.

9. The method of claim 7, wherein the characterizing the level of transparency comprises:
capturing a first image using a camera of the device;
requesting the user to position the sunglasses within a field of view of the camera after capturing the first image;
detecting that the sunglasses are positioned within the field of view of the camera;
capturing a second image using the camera in response to detecting that the sunglasses are positioned within the field of view of the camera; and
estimating a transmission level of the lens based on Commission on Illumination (CIE) XYZ color space characteristics or Red Green Blue (RGB) color model characteristics of the captured first image and the captured second image.

10. The method of claim 9,
wherein the first image and the second image are captured using a same auto exposure level and a same auto white balance level of the camera,
wherein the device remains stationary between capturing the first image and capturing the second image.

11. The method of claim 9, wherein the adjusting the displayed image comprises calculating a display image adjustment factor based on the estimated transmission level.

12. The method of claim 11, wherein the adjusting the displayed image further comprises selecting at least a display image tone adjustment curve or one or more display image tone adjustment values based on the calculated display image adjustment factor.

13. The method of claim 9, further comprising storing the estimated transmission level of the lens as a characteristic of the sunglasses.

14. The method of claim 7, wherein the characterizing the level of transparency comprises:
comparing a skin tone of an exposed portion of a face of the user with a skin tone of a covered portion of the face, the covered portion being covered by the sunglasses.

15. The method of claim 1, wherein the one or more characteristics of the previously characterized object are stored at the device.

16. A method of operating a device, comprising:
receiving a base image for display at the device;
sensing a presence of one or more vision-altering objects located between the device and at least one eye of a user;
processing the base image for the display at the device, to reduce distortion perceived by the user when viewing the display of the base image, in response to sensing the presence of the one or more vision-altering objects,
wherein the distortion is induced by at least two of a plurality of sources, the plurality of sources comprising the one or more vision-altering objects, ambient light, and physiology of an eye of the user; and
displaying the processed base image.

17. The method of claim 16, wherein the processing the base image comprises applying a calculated transform to the base image to reduce the distortion perceived by the user.

18. The method of claim 17,
wherein the calculated transform is calculated by applying a first transform of a plurality of transforms to a second transform of the plurality of transforms,
wherein the first transform is for compensating for a first component of the distortion, the first component caused by a first source of the at least two of the plurality of sources, and
wherein the second transform is for compensating for a second component of the distortion, the second component caused by a second source of the at least two of the plurality of sources.

19. The method of claim 18, further comprising applying a third transform to the base image to which the calculated transform is applied, in order to reduce the occurrence of image saturation.

20. The method of claim 19, wherein the third transform is a nonlinear function.

21. The method of claim 18, further comprising selecting the third transform from among a second plurality of transforms based on a pixel profile of the base image.

22. The method of claim 21, wherein the pixel profile of the base image includes at least an average brightness, a histogram, a range, an overall contrast or a sharpness level of the base image.

23. The method of claim 17, wherein the calculated transform is for a Red (R) channel, a Green (G) channel or a Blue (B) channel of the base image.

24. The method of claim 16, wherein the one or more vision-altering objects comprise at least a filter disposed at a display of the device or eyewear worn by the user.

25. An apparatus comprising:
a memory; and
at least one processor coupled to the memory and configured to:
determine whether a vision-altering object is present between the apparatus and at least one eye of a user;
identify the vision-altering object as corresponding to a previously characterized object in response to determining that the vision-altering object is present between the apparatus and the at least one eye of the user; and
adjust an image displayed at the apparatus based on one or more characteristics of the previously characterized object.

26. The apparatus of claim 25,
wherein the vision-altering object comprises sunglasses, and
wherein the at least one processor is further configured to estimate a transmission level of a lens of the sunglasses.

27. The apparatus of claim 26, wherein the at least one processor is further configured to select at least a display image tone adjustment curve or one or more display image tone adjustment values based on the estimated transmission level of the lens.

28. An apparatus comprising:
a memory; and
at least one processor coupled to the memory and configured to:
receive a base image for display at the apparatus;
sense a presence of one or more vision-altering objects located between the apparatus and at least one eye of a user;
process the base image for the display at the apparatus, to reduce distortion perceived by the user when viewing the display of the base image, in response to sensing the presence of the one or more vision-altering objects,
wherein the distortion is induced by at least two of a plurality of sources, the plurality of sources comprising the one or more vision-altering objects, ambient light, and physiology of an eye of the user; and
display the processed base image.

29. The apparatus of claim 28, wherein the at least one processor is configured to process the base image by applying a calculated transform to the base image to reduce the distortion perceived by the user.

30. The apparatus of claim 29, wherein the at least one processor is further configured to:
select an additional transform from among a plurality of transforms based on a pixel profile of the base image; and
apply the additional transform to the base image to which the calculated transform is applied, in order to reduce the occurrence of image saturation.
